(19) United States
(12) Patent Application Publication
(10) Pub. No.: US 2005/0191388 A1
(43) Pub. Date: Sep. 1, 2005

(54) Snack chip

(76) Inventor: Wyntoun Xavier Henderson, Dallas, TX (US)

Correspondence Address: RUBEN C. DELEON;WINSTEAD SECHROST & MINICK P.C., P.O. BOX 50784, DALLAS, TX, 75201, US

(21) Appl. No.: 10/892,794

(22) Filed: Jul. 16, 2004

Related U.S. Application Data
(60) Provisional application No. 60/488,579, filed on Jul. 18, 2003.

(51) Int. Cl. A23L 3/00

(52) U.S. Cl. 426/243

(57) ABSTRACT

The present disclosure provides a system and method for a new and improved snack chip.

### BACKGROUND OF THE INVENTION

The present invention relates generally to snack chips and, more particularly, to a method and system for creating a new and improved snack chip.

The snack chip industry has produced several variances of chip products, from different flavors to different shapes. The manufacturers' main focus is to intrigue and lure the consumers to purchase their individualized products and convince consumers that their product is superior to their competitors.

One aspect of the snack industry that remains constant among them all is the general preparation of making a snack chip. The preparation process of making a snack chip involves the introduction of high levels of fatty ingredients with a varying percentage being saturated fat. Although certain amounts of fat are necessary in a health diet, deep-fat-fried snack foods may contain as much as 50% by weight of fat, which is soaked into the food product during the deep-fat frying process. A consumer wide favorite of snack chips is the potato chip. Conventional potato chips are prepared by placing raw or blanched potato slices into deep-fat or oil cookers, with the deep-fat or oil frying, resulting in a reduction of moisture content to less than 5%, but also resulting in an undesirable increase in the oil or fat content of the range about 30-50% of the total weight of the chip. This high fat content is undesirable in the diet when potato chips are consumed in large quantities, and the high fat content also leads to shortened shelf life of the potato chip due to the infused fat becoming rancid over a period of time.

In light of the growing concerns of fat and calorie intake by consumers, many of these same industries have rushed to create a recipe for a low fat yet great tasting chip. These industries have had to reduce the amount of oil and deep-fat-frying while retaining product features required for consumer acceptance, such as crispness, a pleasing and wrinkled texture, an acceptable taste and a light brown appearance after cooking. In one approach, non-fatty liquids such as silicones were substituted for the cooking fat. In another approach, only a portion of the cooking operation was carried out in a deep fat fryer, with the remaining portion being accomplished in an air-circulating oven or a microwave oven. Various other types of heaters such as radiant heaters have also been tried. Such preparations and recipes for a reduced fat snack chip have left most consumers unsatisfied with the resulted taste of the snack chip.

Therefore, what consumers need is a system and method that provides a low fat snack chip with a crispness, pleasing texture, a great taste and a nice appearance after cooking.

### SUMMARY OF THE INVENTION

The present invention provides a new and improved snack chip.

A snack chip food made entirely from fully cooked Turkey meat processed as bacon crisped, low fat instant meals originally seasoned and packaged as a snack. The shape may vary with breakage but is first rectangular shaped or drumstick shaped chips that are light in texture and formulated with great bacon flavor or hot and spicy flavor thinly sliced snack chips.

Therefore, in accordance with the previous summary, objects, features and advantages of the present disclosure will become apparent to one skilled in the art from the subsequent description and the appended claims taken in conjunction with the accompanying drawings.

### BRIEF DESCRIPTION OF THE DRAWINGS

FIG. 1 is a perspective view of one of the embodiments;

FIG. 2 is a cross sectional side view of the first embodiment;

FIG. 3 is a plan view of the first embodiment;

FIG. 4 is a perspective view of a second embodiment;

FIG. 5 is a perspective view of a third embodiment; and

FIG. 6 is cross sectional side view of another embodiment.

### DETAILED DESCRIPTION OF THE PREFERRED EMBODIMENTS

The present disclosure can be described by the embodiments given below. It is understood, however, that the embodiments below are not necessarily limitations to the present disclosure, but are used to describe a typical implementation of the invention.

Before you can initiate the preparation process, you must have the proper ingredients. Such ingredients include; thinly cut market fresh turkey bacon, commercial hot sauce seasoning (optional) and light garlic sprinkles.

Cut the turkey bacon meat into various shapes; some odd shapes may be in the shape of a turkey leg or rectangle bacon slice to represent the nature of the snack chip. These shapes are generally 3.5 cm×3.5 cm×2 mm in dimension. Each strip should make up to approximately 5 shapes.

Apply the commercial hot sauce seasoning (optional) and light garlic sprinkles to the entire area of the batch of shapes.

Place the shapes separately on a ceramic plate; you should be able to fit approximately 25 shapes onto a plate, or equivalent with an absorbent layer of paper towels between the shapes and the ceramic plate, in order to absorb the displaced fats (due to cooking of the meat).

Place the ceramic plate with the shapes, inside a microwave oven, at a medium temperature, for approximately 8.5 minutes. Cooking times may vary due to batch amount, oven size, and various other factors such as climate and atmospheric pressure.

Immediately remove the baked shapes and place into a cool container, in order to prevent trapped grease in the absorbent paper toweling, from re-entering chips.

Once the chips have cooled for approximately 2 minutes, the snack chips are ready to serve.

In this embodiment, the turkey bacon chips is packaged in a variety of 2-10 ounce printed foil bags, and sold for retail.

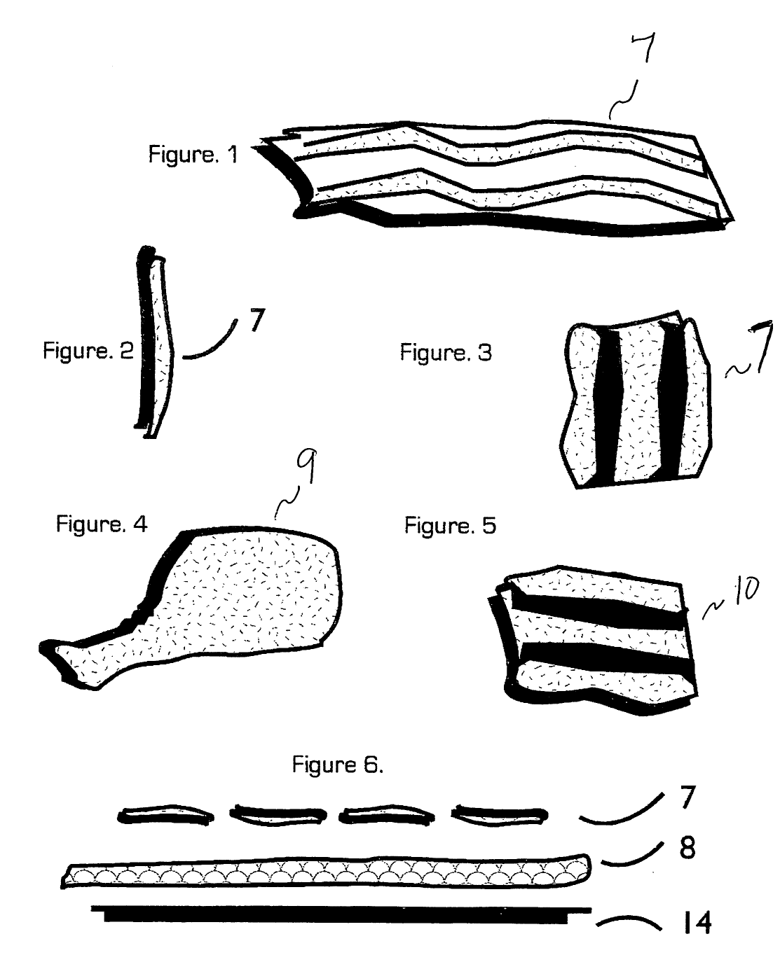

Now referring to FIG. 1, a perspective view of an illustrative rectangular snack chip food invention 7 with is shown.

Now referring to FIG. 2, a cross sectional side view of the snack chip 7 is shown.

Now referring to FIG. 3, a plan view is shown of an illustrative snack chip 7.

Now referring to FIG. 4, a perspective view is shown of a third alternate embodiment of the present invention illustrative as drum stick shaped snack chip 9.

Now referring to FIG. 5, a perspective view is shown of a square shaped snack chip 10.

Now referring to FIG. 6, a cross sectional side view is shown of several snack chips 7 positioned during the cooking process with an absorbent layer 8 which is laid over a ceramic plate 14.

It is understood that several modifications, changes and substitutions are intended in the foregoing disclosure and in some instances some features of the invention will be employed without a corresponding use of other features. Accordingly, it is appropriate that the appended claims be construed broadly and in a manner consistent with the scope of the invention.

1. A method for producing a snack chip, the method comprising:
cutting a bacon product into shapes about the size of a snack chip;
season the shapes of bacon with seasoning;
bake the shapes of the turkey bacon in an oven;
set the cooked shapes of bacon in a cool container; and
serve the cooked shapes of bacon.

2. The method of claim 1 wherein the bacon product is turkey bacon.

3. The method of claim 1 wherein the shape resembles a turkey leg.

4. The method of claim 1 wherein the oven is a microwave oven and cooks the shapes between about 8 and 9 minutes.

5. The method of claim 1 wherein the shapes of bacon are placed in a cool container for about 2 minutes.

6. The method of claim 1 further including packaging the shapes in a cylindrical container.

7. The method of claim 1 further including packaging the shapes in a small foil bag less than 5 ounces in size.

8. The method of claim 1 further including packaging the shapes in a small foil bag more than 8 ounces in size.

9. A method for producing a snack chip, the method comprising:
cutting turkey bacon into shapes about the size of a snack chip;
season the shapes of the turkey bacon with light garlic sprinkles;
bake the shapes of the turkey bacon in a microwave oven for about 8 and ½ minutes;
set the cooked shapes of turkey bacon in a cool container for about 2 minutes; and
serve the cooked shapes of turkey bacon.

10. The method of claim 9 further including packaging the shapes in a cylindrical container.

11. The method of claim 9 further including packaging the shapes in a small foil bag less than 5 ounces in size.

12. The method of claim 9 further including packaging the shapes in a small foil bag more than 8 ounces in size.
